(19) United States
(12) Patent Application Publication
(10) Pub. No.: US 2013/0194480 A1
(43) Pub. Date: Aug. 1, 2013

(54) IMAGE PROCESSING APPARATUS, IMAGE PROCESSING METHOD, AND RECORDING MEDIUM

(71) Applicant: Sony Corporation, Tokyo (JP)

(72) Inventors: Yoko Fukata, Tokyo (JP); Toshiki Ono, Tokyo (JP); Masanori Mikami, Kanagawa (JP)

(73) Assignee: Sony Corporation, Tokyo (JP)

(21) Appl. No.: 13/744,868

(22) Filed: Jan. 18, 2013

(30) Foreign Application Priority Data
Jan. 26, 2012 (JP) 2012-013922

(51) Int. Cl. H04N 5/232

(52) U.S. Cl. CPC H04N 5/23293
USPC 348/333.12

(57) ABSTRACT

There is provided an image processing apparatus including a display control unit that, when an object frame showing an object included in an input image and the input image are displayed on a display unit and a trimming frame showing a trimming region of the input image is further displayed on the display unit, changes display of the object frame.

### BACKGROUND

The present disclosure relates to an image processing apparatus, an image processing method, and a recording medium.

Recently, when an image is imaged using an imaging apparatus such as a digital camera or a captured image is processed by a personal computer (PC), it becomes general to overlap a variety of information to an image and display the information. As an example of related technology, technology for displaying a recommended composition frame or an object frame on a through image of a digital camera has been described in Japanese Patent Application Laid-Open No. 2011-087131.

### SUMMARY

However, when a large amount of information is overlapped to an image and the information is displayed using the technology described in Japanese Patent Application Laid-Open No. 2011-087131, display becomes complicated and it may become difficult to view the image. That is, even if the variety of information is information useful for a user, overlapping the variety of information to the image and displaying the information do not necessarily improve convenience of the user.

It is desirable to provide an image processing apparatus, an image processing method, and a recording medium that enable appropriate information to be provided to a user, while visibility of an image is secured.

According to an embodiment of the present disclosure, there is provided an image processing apparatus including a display control unit that, when an object frame showing an object included in an input image and the input image are displayed on a display unit and a trimming frame showing a trimming region of the input image is further displayed on the display unit, changes display of the object frame.

Further, according to an embodiment of the present disclosure, there is provided an image processing method including, when an object frame showing an object included in an input image and the input image are displayed on a display unit and a trimming frame showing a trimming region of the input image is further displayed on the display unit, changing display of the object frame.

Further, according to an embodiment of the present disclosure, there is provided a computer readable recording medium on which a program is recorded. The program causes a computer to realize a function of, when an object frame showing an object included in an input image and the input image are displayed on a display unit and a trimming frame showing a trimming region of the input image is further displayed on the display unit, changing display of the object frame.

According to the configuration described above, when the trimming image is displayed with the input image, display of the object frame that is already displayed with the input image changes. As such, if display aspects are adjusted between the frames displayed with the input image, visibility of the input image can be maintained even when information of the trimming frame is added to the image.

According to the embodiments of the present disclosure described above, appropriate information can be provided to a user while visibility of an image is secured.

### BRIEF DESCRIPTION OF THE DRAWINGS

FIG. 1 is a schematic block diagram illustrating a functional configuration of a digital still camera according to an embodiment of the present disclosure;

FIG. 2 is a flowchart illustrating a standby process of the digital still camera according to the embodiment of the present disclosure;

FIG. 3 is a flowchart illustrating an imaging process of the digital still camera according to the embodiment of the present disclosure;

FIGS. 4A to 4D are diagrams illustrating display examples of a through image in the digital still camera according to the embodiment of the present disclosure;

FIGS. 5A and 5B are diagrams illustrating display examples of a through image in the digital still camera according to the embodiment of the present disclosure;

FIGS. 6A and 6B are diagrams illustrating display examples of a through image in the digital still camera according to the embodiment of the present disclosure;

FIG. 7 is a diagram illustrating a display example of a preview image in the digital still camera according to the embodiment of the present disclosure;

FIGS. 8A to 8D are diagrams illustrating display examples of a preview image in the digital still camera according to the embodiment of the present disclosure; and

FIGS. 9A to 9C are diagrams illustrating display examples of a preview image in the digital still camera according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

1. Functional Configuration

2. Process Flow

3. Display Example of Through Image

4. Display Example of Preview image

5. Supplement

In the following description, an embodiment of the present disclosure according to a digital still camera that is an example of an image processing apparatus will be disclosed. The image processing apparatus according to the embodiment of the present disclosure is not limited to the digital still camera and may be any one of various apparatuses that have a function of processing an input image and generating a trimming image. The embodiment of the present disclosure includes a method of processing an input image and generating a trimming image, a program for causing a computer to realize a function of processing an input image and generating a trimming image, and a computer readable recording medium on which the program is recorded.

(1. Functional Configuration)

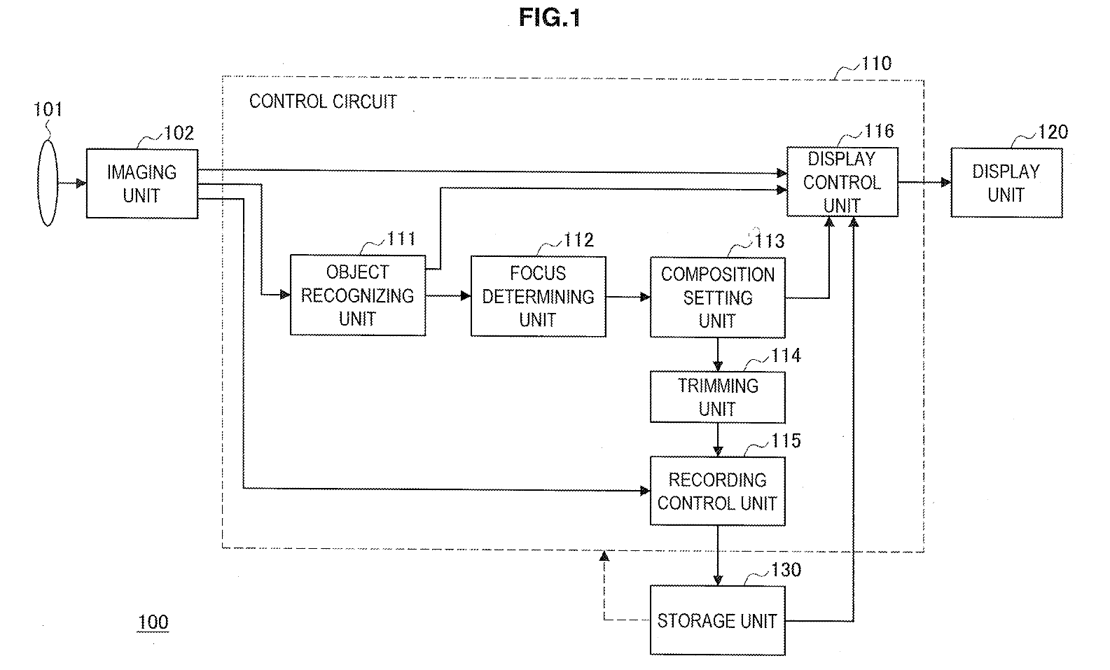

First, a functional configuration of a digital still camera according to an embodiment of the present disclosure will be described with reference to FIG. 1. FIG. 1 is a schematic block diagram illustrating the functional configuration of the digital still camera.

A digital still camera 100 includes an imaging optical system 101, an imaging unit 102, a control circuit 110, a display unit 120, and a storage unit 130. The control circuit 110 realizes functions of an object recognizing unit 111, a focus determining unit 112, a composition setting unit 113, a trimming unit 114, a recording control unit 115, and a display control unit 116. In addition to the functional configuration illustrated in FIG. 1, the digital still camera 100 may include a structural element such as an operation unit that is generally provided in the digital still camera.

The imaging optical system 101 includes optical components such as various lenses such as a focus lens and a zoom lens, an optical filter, and a diaphragm. An optical image (object image) that is incident from an object is formed on an exposure surface of an imaging element included in the imaging unit 102, through the optical components included in the imaging optical system 101.

The imaging unit 102 includes an imaging element such as a charge coupled device (CCD) and a complementary metal oxide semiconductor (CMOS), a timing generator to drive the imaging element, and a signal processing circuit. The signal processing circuit processes an analog image signal output when the imaging element executes photoelectric conversion on the object image, converts the analog image signal into a digital image signal, and outputs the digital image signal to the control circuit 110. The signal processing circuit is realized by a digital signal processor (DSP).

The control circuit 110 realizes the functions of the object recognizing unit 111, the focus determining unit 112, the composition setting unit 113, the recording control unit 115, and the display control unit 116 and controls operations of the individual units of the digital still camera 100. The control circuit 110 is realized by a central processing unit (CPU) that operates on the basis of a program stored in the storage unit 130 and realizes the functions described above. A part or all of the functions of the control circuit 110 may be realized by the DSP, similar to the signal processing circuit. Hereinafter, individual functional units that are realized by the control circuit 110 will be described.

The object recognizing unit 111 analyzes a digital image signal of an input image acquired from the imaging unit 102 and recognizes an object included in the input image. In this case, the object is a face of a person. In addition, the object may be any one of various objects such as a face of an animal, a flower, and a dish. The object recognizing unit 111 calculates a region of the object using an algorithm such as wavelet transform or Haar feature detection. For example, in the case of the face of the person, the region of the object may be a coordinate value of a smallest rectangular shape in which a jaw, ears, and eyebrows are included. The region of the object is not limited to the rectangular shape and may have a triangular shape or an elliptical shape. The object recognizing unit 111 may recognize a direction of the object in addition to the region of the object.

When a plurality of objects are included in the input image, the object recognizing unit 111 may be set to detect all of the objects or may be set to limit the number of objects according to rankings of sizes of the regions of the objects and detect the objects. The object recognizing unit 111 may set a preferential object from the plurality of objects, on the basis of the position or the size of each of the recognized objects. The preferential object is an object that is assumed as an object having the highest priority for a user, among the objects. When the preferential object is set, the object recognizing unit 111 may include information showing the preferential object in information of the objects. The information of the object that is recognized by the object recognizing unit 111 is provided to the focus determining unit 112 and the composition setting unit 113. The object recognizing unit 111 may provide information of the region of the object to the display control unit 116.

The focus determining unit 112 determines whether the object recognized by the object recognizing unit 111 is focused on. The focus determining unit 112 determines whether the object is focused on, using the same method as automatic focusing, such as a contrast detection method or a phase difference detection method. For example, when the contrast detection method is used, the focus determining unit 112 determines whether a contrast in the region of the object of the input image is equal to or more than a predetermined threshold value or is more than a contrast in the other region and determines whether the object is focused on. When the phase difference detection method is used, the focus determining unit 112 determines whether a lens of the imaging optical system 101 is focused on the object, on the basis of a phase difference in the region of the object detected using a light measurement sensor (not illustrated in the drawings) such as a line sensor, and determines whether the object is focused on. The focus determining unit 112 provides a determination result on whether the object is focused on to the composition setting unit 113. When a plurality of objects are recognized by the object recognizing unit 111, the focus determining unit 112 may determine whether the preferential object is focused on.

The composition setting unit 113 sets a trimming region of the input image, such that the object is arranged with a predetermined composition. In this embodiment, the composition setting unit 113 uses a three division composition as a predetermined composition. The predetermined composition may be another composition such as a two division composition. The composition setting unit 113 sets a trimming region according to a position, a size, and a direction of the object recognized by the object recognizing unit 111. Specifically, the composition setting unit 113 determines a size of the trimming region according to the size of the object and determines a position of the trimming region such that the object is arranged at any one of intersections obtained by dividing the trimming region by three. The composition setting unit 113 provides information of the set trimming region to the trimming unit 114 and the display control unit 116.

In this case, when the plurality of objects are included in the input image, the composition setting unit 113 may set the trimming region such that the previously set preferential object among the plurality of objects is arranged with a predetermined composition. The composition setting unit 113 may set the trimming region such that a related object deeply related to the preferential object among the other objects is included. When the trimming region is beyond a range of the input image, the composition setting unit 113 may not set the trimming region.

When it is determined by the focus determining unit 112 that the object is focused on, the composition setting unit 113 may set a composition. The reason is as follows. When the object is focused on, precision of the composition setting becomes high. When the object is not focused on, it is likely for a composition setting operation to become finally failed, even though a trimming image is generated according to a set composition.

The trimming unit 114 generates a trimming image of the trimming region set by the composition setting unit 113, from the input image. At this time, the trimming unit 114 may perform a process (super-resolution processing) of pixel interpolation to increase resolution in order to expand the trimming image to a size of the input image.

When imaging is executed by the digital still camera 100, the recording control unit 115 records the input image and the trimming image generated by the trimming unit 114 as image data in the storage unit 130. When the trimming region is not set by the composition setting unit 113, the recording control unit 115 may record only the input image. When the trimming image is recorded, the recording control unit 115 may record image data of the corresponding input image, information of the trimming region, and information of the region of the object used for setting the composition in the storage unit 130.

The display control unit 116 displays the input image as a through image before imaging and a preview image after the imaging on the display unit 120. First, when the input image is displayed as the through image, the display control unit 116 acquires an image signal of the input image from the imaging unit 102. The display control unit 116 acquires the information of the region of the object included in the input image from the object recognizing unit 111, overlaps an object frame showing the object to the input image, and displays the object frame. The display control unit 116 acquires the information of the trimming region from the composition setting unit 113, further overlaps a trimming frame showing the trimming region to the input image, and displays the trimming frame.

In this case, when the trimming frame is overlapped to the input image and is displayed, the display control unit 116 changes display of the object frame to be already overlapped to the input image and displayed. For example, when the trimming frame is being displayed, the display control unit 116 may not display the object frame partially or entirely. The display control unit 116 may set an animation such as flickering to the object frame or change a color and transmittance of the object frame. Thereby, the user can easily view the trimming frame or easily distinguish between the trimming frame and the object frame. A specific example of the change in the display of the object frame will be described below.

Meanwhile, when the input image is displayed as the preview image, the display control unit 116 acquires the image data of the input image and the trimming image recorded in the storage unit 130 and displays the images on the display unit 120 in parallel. Alternatively, the display control unit 116 may display the images on the display unit 120 sequentially. At this time, as will be described below, the display control unit 116 displays the images such that the images can be distinguished from one another. As described above, when the information of the trimming region or the object region is additionally recorded in addition to the input image recorded in the storage unit 130, the display control unit 116 may overlap the trimming frame or the object frame showing the trimming region or the object region to the input image and display the trimming frame or the object frame. The display control unit 116 may display only the input image as the preview image and overlap the trimming frame to the input image and display the trimming frame, so that the trimming region can be recognized.

The display unit 120 is configured using a liquid crystal display (LCD) or an organic electro-luminescence (EL) display. The display unit 120 displays a variety of information regarding the digital still camera 100 for the user, according to control of the display control unit 116.

A variety of data regarding processes of the digital still camera 100 is stored in the storage unit 130. The storage unit 130 may be a semiconductor memory such as a flash read only memory (ROM) or a dynamic random access memory (DRAM), an optical disc such as a digital versatile disc (DVD) or a compact disc (CD), or a hard disk. Alternatively, the storage unit 130 may be a storage device embedded in the digital still camera 100 or a recording medium removable from the digital still camera 100. The storage unit 130 may include a plurality of kinds of storage devices or recording media. The image data of the input image or the trimming image is stored in the storage unit 130 by the recording control unit 115. In addition, a program for causing the CPU of the control circuit 110 to execute the functions may be stored in the storage unit 130.

(2. Process Flow)

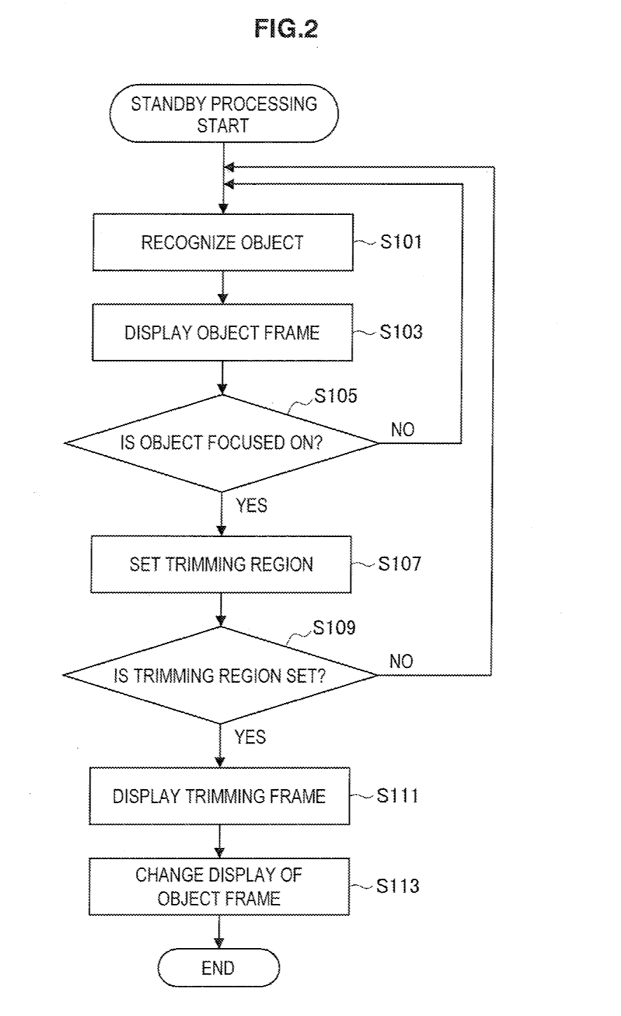

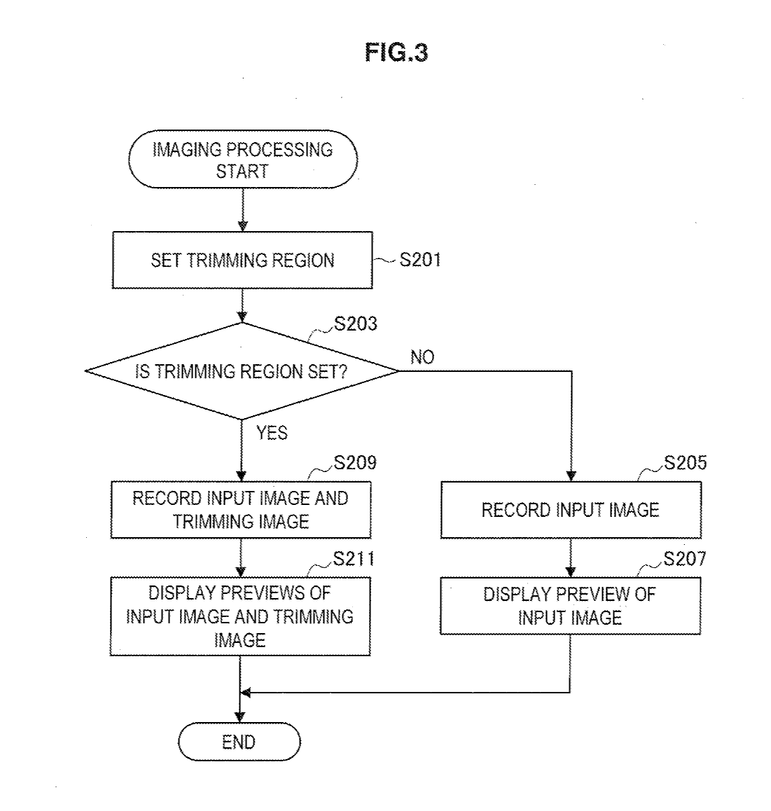

Next, a process flow of the digital still camera according to the embodiment of the present disclosure will be described with reference to FIGS. 2 and 3. FIG. 2 is a flowchart illustrating a standby process of the digital still camera 100. FIG. 3 is a flowchart illustrating an imaging process of the digital still camera 100.

(Standby Process)

The standby process illustrated in FIG. 2 is a process for displaying a through image on the display unit 120 of the digital still camera 100, before imaging. The standby process may be executed when a shutter button provided as an operation unit in the digital still camera 100 is pressed halfway or may be continuously executed when the digital still camera 100 starts.

During the standby process, first, the object recognizing unit 111 analyzes a digital image signal of the input image acquired from the imaging unit 102 and recognizes the object included in the input image (S101). The display control unit 116 acquires the information of the region of the object from the object recognizing unit 111, overlaps the object frame to the input image, and displays the object frame (step S103).

Next, the focus determining unit 112 determines whether the object recognized by the object recognizing unit 111 is focused on (step S105). In this case, when it is determined that the object is not focused on, the process returns to step S101. That is, the display control unit 116 displays the input image to which only the object frame is overlapped as the through image on the display unit 120.

Meanwhile, when it is determined in step S105 that the object is focused on, the composition setting unit 113 sets the trimming region such that the object is arranged with a predetermined composition, according to the position, the size, and the direction of the object recognized by the object recognizing unit 111 (step S107). As described above, when the trimming region is beyond the range of the input image, the composition setting unit 113 may not set the composition.

Next, the display control unit 116 determines whether the trimming region is set by the composition setting unit 113 (step S109). In this case, when it is determined that the trimming region is not set, the process returns to step S101. In this case, the display control unit 116 displays the input image to which only the object frame is overlapped as the through image on the display unit 120.

Meanwhile, when it is determined in step S109 that the trimming region is set, the display control unit 116 acquires the information of the trimming region from the composition setting unit 113, overlaps the trimming frame to the input image, and displays the trimming frame (step S111). At this time, the display control unit 116 changes display of the object frame to be overlapped to the input image and displayed (step S113). In this case, the display control unit 116 displays the input image to which the trimming frame and the object frame whose display has changed are overlapped as the through image on the display unit 120.

As described above, the change in the display of the object frame in step S113 includes the case of not displaying the object frame partially or entirely. Therefore, both the trimming frame and the object frame may not be displayed visually on the display unit 120 after the standby process.

The standby process may be repetitively executed for each frame of the image acquired by the imaging unit 102. That is, when the object is not focused on or the composition is not set after the trimming frame is displayed on the display unit 120, the display of the trimming frame may disappear. At this time, the display of the object frame returns to the display when the trimming frame is not displayed, that is, when there is no change in step S113.

(Imaging Process)

The imaging process illustrated in FIG. 3 is a process for displaying a preview image on the display unit 120 of the digital still camera 100, after imaging. The imaging process may be executed when the shutter button provided as the operation unit in the digital still camera 100 is pressed fully.

During the imaging process, first, the composition setting unit 113 sets the trimming region such that the object is arranged with a predetermined composition, according to the position, the size, and the direction of the object recognized by the object recognizing unit 111 (step S201). At this time, similar to the standby process, the composition setting unit 113 may not set the trimming region, when the object is not focused on. Different from the standby process, the composition setting unit 113 may set the trimming region, regardless of whether the object is focused on. As described above, when the trimming region is beyond the range of the input image, the composition setting unit 113 may not set the trimming region.

Next, the trimming unit 114 determines whether the trimming region is set by the composition setting unit 113 (step S203). The determination may be performed using the result of the setting of the trimming region in the standby process immediately before the imaging process is executed. That is, when the shutter button is pressed halfway before the shutter button is pressed fully, the trimming unit 114 may determine whether the trimming region may be set by step S107 of the immediately previous standby process. In this case, the composition setting unit 113 may not necessarily execute step S201 described above.

When it is determined in step S203 that the trimming region is not set, the recording control unit 115 records only the input image as the image data in the storage unit 130 (step S205). Next, the display control unit 116 acquires the image data of the input image from the storage unit 130 and displays a preview of the input image on the display unit 120 (step S207).

Meanwhile, when it is determined in step S203 that the trimming region is set, the trimming unit 114 generates the trimming image of the trimming region from the input image and the recording control unit 115 records each of the input image and the trimming image as the image data in the storage unit 130 (step S209). At this time, the trimming unit 114 may expand the trimming image to the size of the input image, as described above. The recording control unit 115 may record the image data of the input image, the information of the trimming region, and the information of the region of the object used for setting the composition in the storage unit 130.

Next, the display control unit 116 acquires the image data of the input image and the trimming image from the storage unit 130 and displays previews of the input image and the trimming image on the display unit 120 (step S211). At this time, the display control unit 116 displays the images on the display unit 120 in parallel or sequentially. The display control unit 116 displays the images such that the images can be distinguished from one another. The display control unit 116 may overlap the trimming frame or the object frame to the input image and display the trimming frame or the object frame, on the basis of the information of the trimming region or the information of the object region recorded with the image data of the input image. The display control unit 116 may display only the input image as the preview image, overlap the trimming frame to the input image, and display the trimming frame, so that the trimming region can be recognized.

(3. Display Example of Through Image)

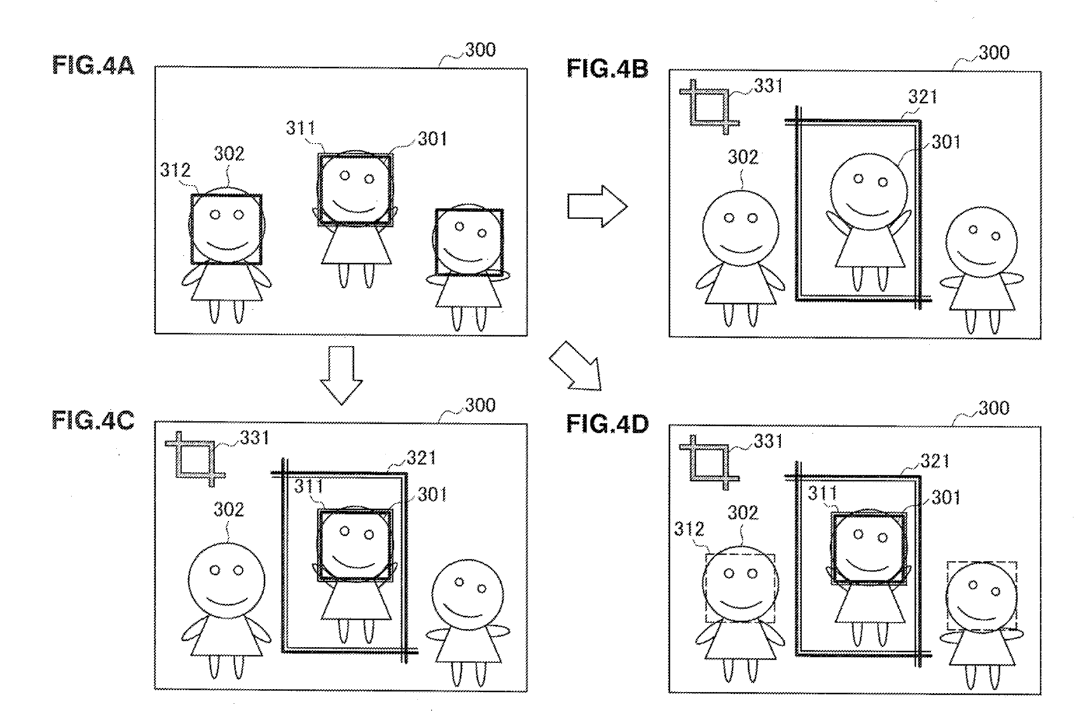

Next, display examples of a through image in the digital still camera according to the embodiment of the present disclosure will be described with reference to FIGS. 4A to 6D. FIGS. 4A to 6D are diagrams illustrating examples of the through image displayed on the display unit 120 of the digital still camera 100.

### First Display Example

FIGS. 4A to 4D illustrate first display examples of the through image. In these examples, the composition setting unit 113 sets a trimming region such that a preferential object 301 (first object) of objects included in an input image is arranged with a predetermined composition. The objects include another object 302 (second object) in addition to the preferential object 301.

FIG. 4A illustrates a display example of a through image when an object is recognized, but a trimming region is not set. At this time, a region of the preferential object 301 that corresponds to a first object frame 311 is overlapped to the input image 300 and is displayed. A region of the object 302 other than the preferential object that corresponds to a second object frame 312 is overlapped to the input image 300 and is displayed. In this case, the first object frame 311 may be displayed to be more conspicuous than the second object frame 312, to correspond to the preferential object 301. For example, as illustrated in the drawings, the first object frame 311 may be displayed with a line thicker than a line of the second object frame 312. The first object frame 311 may be displayed with transmittance lower than transmittance of the second object frame 312.

FIG. 4B illustrates a display example of a through image when an object is recognized and a trimming region is set. At this time, the display control unit 116 overlaps a trimming frame 321 showing the trimming region to the input image 300 and displays the trimming frame. Meanwhile, the display control unit 116 causes the display of the entire object frames, that is, both the first object frame 311 and the second object frame 312 to disappear, according to the display of the trimming frame 321. Thereby, the user can easily view the trimming frame 321. The display control unit 116 may display a trimming icon 331 showing that a trimming image can be generated to the input image 300 and display the trimming icon.

FIG. 4C illustrates another display example of a through image when an object is recognized and a trimming region is set. At this time, the display control unit 116 overlaps the trimming frame 321 showing the trimming region and the first object frame 311 showing the preferential object 301 used for setting the trimming region to the input image 300 and displays the trimming frame and the first object frame. The first object frame 311 may be displayed with a color different from a color used in the case of FIG. 4A. Meanwhile, the display control unit 116 causes the display of the second object frame 312 to disappear, according to the display of the trimming frame 321. Thereby, the user can easily view the trimming frame 321 and can continuously view the first object frame 311. Therefore, the user can easily recognize the trimming region and the object used for the setting the trimming region being the preferential object 301. Even in this case, the display control unit 116 may overlap the trimming icon 331 to the input image 300 and display the trimming icon.

FIG. 4D illustrates another display example of a through image when an object is recognized and a trimming region is set. At this time, the display control unit 116 overlaps the trimming frame 321 showing the trimming region and the first object frame 311 showing the preferential object 301 used for setting the trimming region to the input image 300 and displays the trimming frame and the first object frame. Meanwhile, the display control unit 116 flickers the display of the second object frame 312, according to the display of the trimming frame 321. The display control unit 116 may not flicker the display of the first object frame 311 or may flicker the display of the first object frame 311 with a period longer than a period of the second object frame.

Thereby, the user can easily view the trimming frame 321 and can continuously view the first object frame 311. Therefore, the user can easily recognize the trimming region, the object used for the setting the trimming region being the preferential object 301, and another object 302 existing in the preferential objects. Even in this case, the display control unit 116 may overlap the trimming icon 331 to the input image 300 and display the trimming icon.

In the example of FIG. 4D, in addition to setting different animations between the first object frame 311 and the second object frame 312 or instead of setting the different animations, the first object frame 311 may be displayed with a color to be more conspicuous than a color of the second object frame 312 (the second object frame is displayed with a color different from a color of the first object frame 311) or transmittance of the second object frame 312 may be set to be higher than transmittance of the first object frame 311.

### Second Display Example

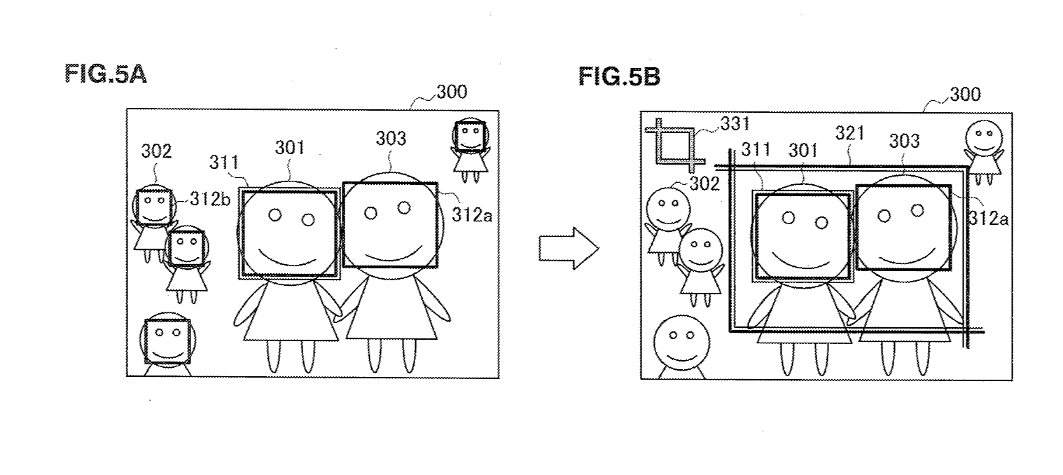

FIGS. 5A and 5B illustrate second display examples of a through image. In these examples, the composition setting unit 113 sets a trimming region such that a preferential object 301 (first object) of objects included in an input image is arranged with a predetermined composition and a related object 303 (third object) which is a part of the other objects 302 (second objects) and is related to the preferential object 301 is included. In this case, the related object 303 is an object that is positioned near the preferential object 301 and has the same size as the size of the preferential object 301.

FIG. 5A illustrates a display example of a through image when an object is recognized, but a trimming region is not set. At this time, a region of the preferential object 301 that corresponds to the first object frame 311 is overlapped to the input image 300 and is displayed. A region of the related object 303 that corresponds to a second object frame 312a and a region of another object 302 that corresponds to a second object frame 312b are overlapped to the input image 300 and are displayed. In this case, the first object frame 311 may be displayed to be more conspicuous than the second object frames 312a and 312b, to correspond to the preferential object 301.

FIG. 5B illustrates a display example of a through image when an object is recognized and a trimming region is set. At this time, the display control unit 116 overlaps the trimming frame 321 showing the trimming region and the first object frame 311 and the second object frame 312a showing the preferential object 301 and the related frame 303 used for setting the trimming region to the input image 300 and displays the frames. The first object frame 311 and the second object frame 312a may be displayed with a color different from a color used in the case of FIG. 5A. Meanwhile, the display control unit 116 causes the display of the second object frame 312b corresponding to the object 302 other than the related object 303 to disappear, according to the display of the trimming frame 321.

Thereby, the user can easily view the trimming frame 321 and the first object frame 311 and can continuously view the second object frame 312a. Therefore, the user can easily recognize the trimming region and the objects used for setting the trimming region being the preferential object 301 and the related object 303. Even in this case, the display control unit 116 may overlap the trimming icon 331 to the input image 300 and display the trimming icon.

In the example of FIG. 5B, the display control unit 116 causes the display of the second object frame 312b to disappear. However, as in the example of FIG. 4D, the display control unit 116 may continuously overlap the second object frame 312b to the input image 300 and display the second object frame 312b with an animation, a color, and transmittance different from those of the first object frame 311 and the second object frame 312a.

### Third Display Example

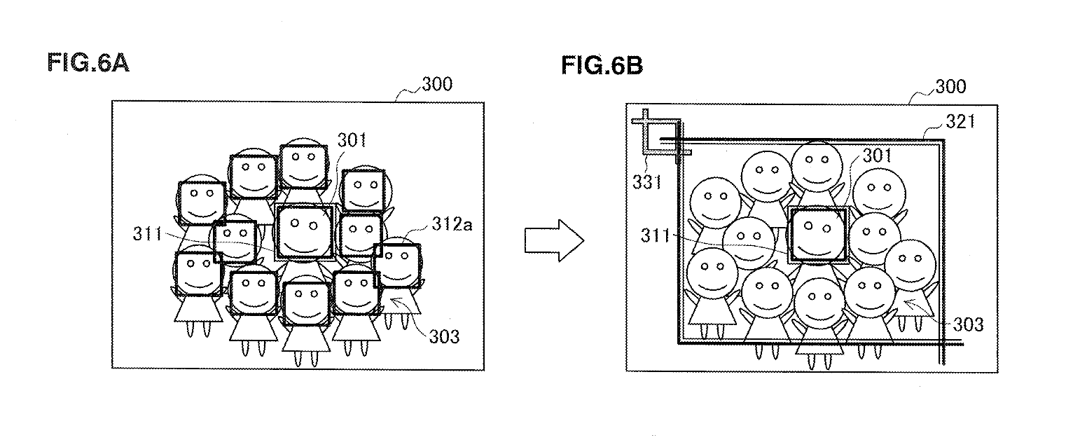

FIGS. 6A and 6B illustrate third display examples of a through image. In these examples, similar to the examples of FIGS. 5A and 5B, the composition setting unit 113 sets a trimming region such that a preferential object 301 (first object) of objects included in an input image 300 is arranged with a predetermined composition and a related object 303 (third object) related to the preferential object 301 among the other objects 302 (second objects) is included.

FIG. 6A illustrates a display example of a through image when an object is recognized, but a trimming region is not set. At this time, a region of the preferential object 301 that corresponds to a first object frame 311 is overlapped to the input image 300 and is displayed. A region of the related object 303 that corresponds to a second object frame 312a is overlapped to the input image 300 and is displayed. In this example, all of the other objects included in the input image 300 are the related objects 303. However, another object 302 may be included in the input image 300 and a second object frame 312b showing another object 302 may be displayed.

FIG. 6B illustrates a display example of a through image when an object is recognized and a trimming region is set. At this time, the display control unit 116 overlaps the trimming frame 321 showing the trimming region and the first object frame 311 showing the preferential object 301 used for setting the trimming region to the input image 300 and displays the trimming frame and the first object frame and causes the display of the second object frame 312a to disappear. This is because the display control unit 116 determines to make the display of the second object frame 312a disappear, according to the display of the trimming frame 321, when the number of related objects 303 included in the input image 300 is compared with a predetermined number and the number of related objects 303 is equal to or more than the predetermined number.

When the number of related objects 303 is decreased to some extent by the display change, the same information as the information in the examples of FIGS. 5A and 5B is provided to the user. Meanwhile, when the number of related objects 303 is large, visibility of the input image 300 including the trimming frame 321 can be preferentially considered by omitting information regarding the related objects 303.

(Conclusion of Display Example of Through Image)

In the display examples of the through image described above, the trimming frame is displayed so that the trimming image can be generated by imaging or the trimming region can be conspicuously provided to the user. In addition, the display of the object frame is changed so that visibility of the input image can be prevented from being deteriorated due to confusing of the overlapped and displayed object frame and trimming frame. Therefore, the user can easily recognize information regarding the trimming image generated when the imaging is executed in advance and can execute the imaging at appropriate timing.

In this case, the change in the display of the object frame when the trimming frame is displayed is to make the display of the object frame disappear. The display of all of the object frames is not made to disappear and the object frame corresponding to the preferential object used for setting the trimming region may be continuously overlapped to the input image and displayed. In this case, the object frames may be displayed in a range in which visibility is not deteriorated, on the basis of the number of displayed object frames. In addition, the visibility of the input image may be secured by setting an animation such as flickering or adjusting a color or transmittance, not making the display of the object frame disappear.

(4. Display Example of Preview Image)

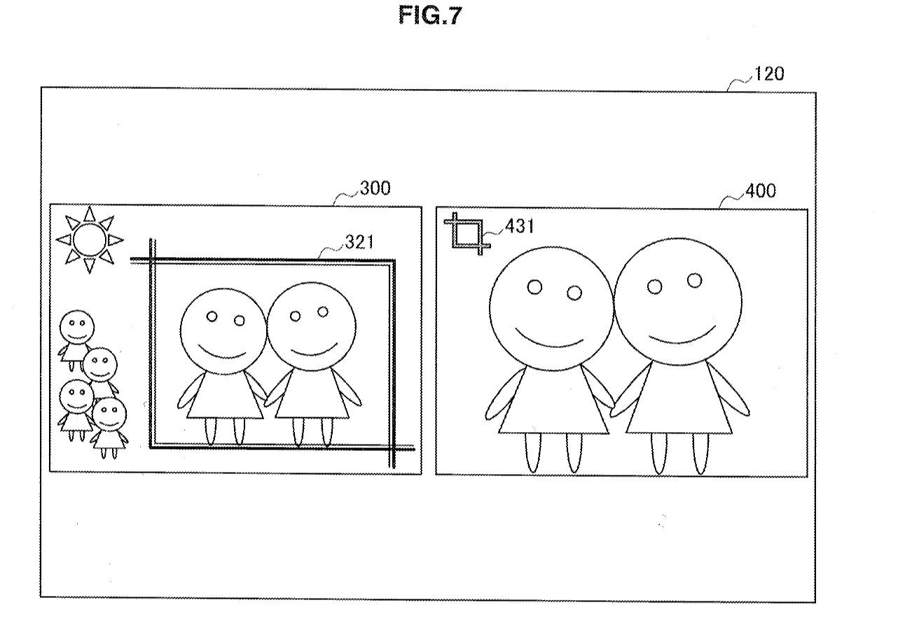

Next, display examples of a preview image in the digital still camera according to the embodiment of the present disclosure will be described with reference to FIGS. 7 to 9C. FIGS. 7 to 9C are diagrams illustrating examples of a preview image displayed on the display unit 120 of the digital still camera 100.

### First Display Example

FIG. 7 illustrates a first display example of a preview image. In this example, an input image 300 and a trimming image 400 are displayed on the display unit 120 in parallel. As described above, when the trimming unit 114 expands the trimming image 400 to the size of the input image 300, the sizes of the input image 300 and the trimming image 400 become almost equal to each other. Therefore, the display control unit 116 displays a trimming frame 321 on the input image 300 and displays a trimming icon 431 on the trimming image 400, so that the user can distinguish between the input image 300 and the trimming image 400. The trimming frame 321 and the trimming icon 431 are displayed to distinguish between the input image 300 and the trimming image 400 and only one of the trimming frame or the trimming icon may be displayed.

### Second Display Example

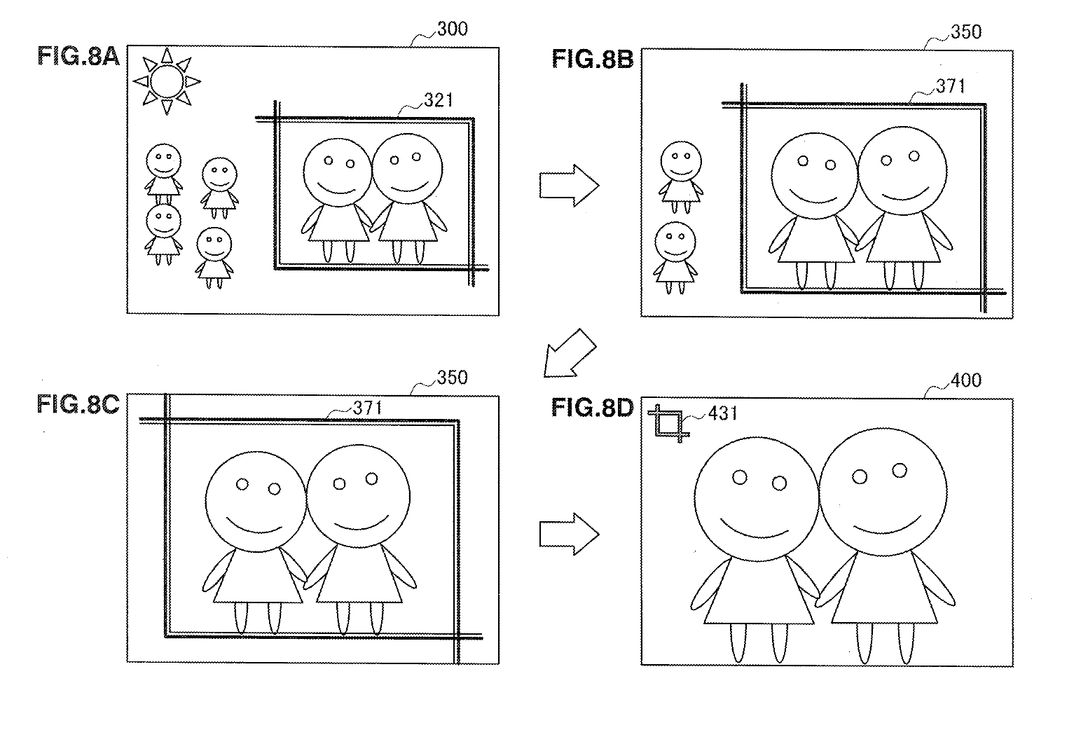

FIGS. 8A to 8D illustrate second display examples of a preview image. In these examples, the input image 300 and the trimming image 400 are sequentially displayed on the display unit 120. At this time, the display control unit 116 display an animation in which a trimming region shown by the trimming frame 321 in the input image 300 of FIG. 8A is gradually expanded, is then changed to intermediate images 350 of FIGS. 8B and 8C, and is finally changed to the trimming image 400 of FIG. 8D.

In this case, the animation is displayed so that the user can distinguish between the input image 300 and the trimming image 400. The display control unit 116 may display the trimming frame 321 on the input image 300 and displays the trimming icon 431 on the trimming image 400, so that the user can easily distinguish between the input image 300 and the trimming image 400. The trimming frame 321 of the input image 300 may be continuously displayed as a trimming frame 371 in the intermediate image 350, such that the user can easily recognize that the trimming frame is being expanded.

### Third Display Example

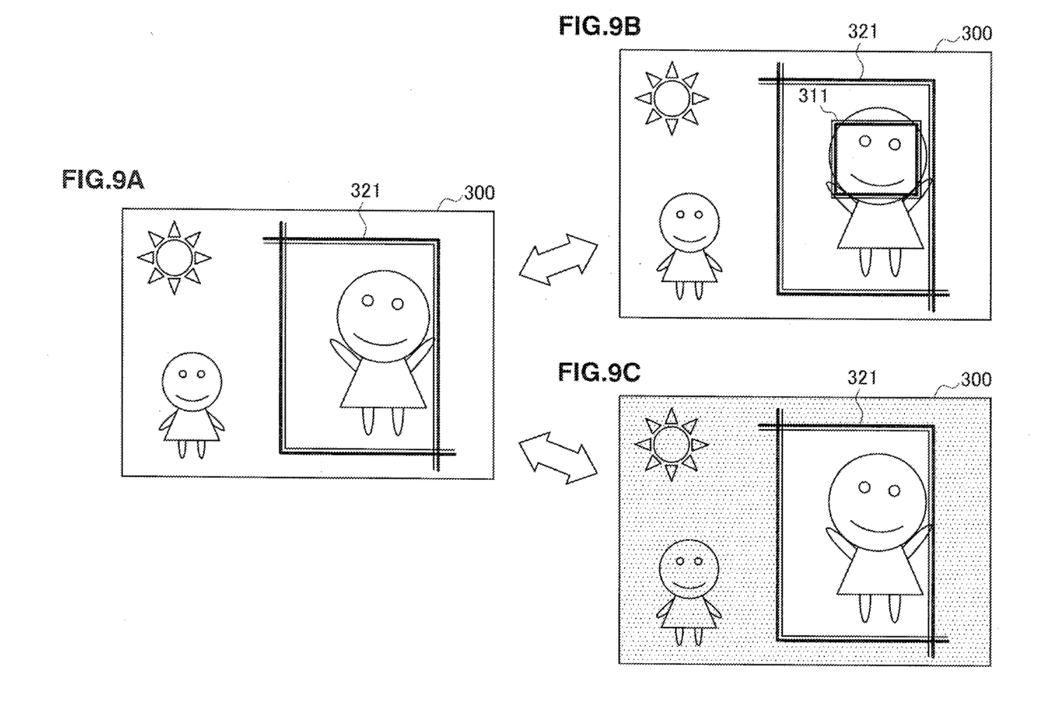

FIGS. 9A to 9C illustrate third display examples of a preview image. In these examples, the trimming frame 321 is overlapped to the input image 300 and is displayed. For example, the display control unit 116 may overlap the trimming frame 321 to the input image 300 and display the trimming frame, as illustrated in FIG. 9A. The display control unit 116 may overlap the trimming frame 321 and the first object frame 311 to the input image 300 and display the trimming frame and the first object frame, as illustrated in FIG. 9B. The display control unit 116 may overlap the trimming frame 321 to the input image 300 and display the trimming frame and emphasize an inner region of the trimming frame 321 and display the inner region, as illustrated in FIG. 9C. In the example of FIG. 9C, an outer region of the trimming frame 321 is displayed slightly darkly so that the inner region of the trimming frame 321 is emphasized.

(Conclusion of Display Example of Preview Image)

In the display examples of the preview image described above, both the input image and the trimming image are displayed or the trimming frame is displayed on the input image, so that the region of the trimming image generated by imaging can be provided conspicuously to the user. Thereby, the user can easily confirm whether the trimming image generated by the imaging is appropriate. At this time, the trimming icon may be displayed on the trimming image or the animation in which the input image is expanded to change into the trimming image may be displayed, such that the user can easily distinguish between the input image and the trimming image.

(5. Supplement)

The embodiment of the present disclosure is not limited to the configurations described above and may be variously modified like the following example.

For example, the image processing apparatus according to the embodiment of the present disclosure is not limited to the digital still camera and may be a mobile phone (smart phone) having an imaging function or a portable terminal such as a tablet personal computer (PC). In this case, the image processing apparatus may display a through image and a preview image, similar to the example of the digital still camera. The image processing apparatus may be an information processing apparatus such as a desktop PC that does not have an imaging function. In this case, the image processing apparatus acquires an image imaged by another apparatus as an input image.

The display of the screen according to the embodiment of the present disclosure is not limited to the display of the through image and the preview image and may be applied to display in various scenes, according to a use method of the image processing apparatus by the user. For example, when the image processing apparatus processes a previously captured image and generates a trimming image, the same display as the example of the through image may be applied to reproduction display of the captured image. The same display as the example of the through image may be applied to display of a preview image.

It should be understood by those skilled in the art that various modifications, combinations, sub-combinations and alterations may occur depending on design requirements and other factors insofar as they are in the scope of the appended claims or the equivalents thereof.

Additionally, the present technology may also be configured as below.

(1) An image processing apparatus including:

a display control unit that, when the object frame showing an object included in an input image and the input image are displayed on a display unit and a trimming frame showing a trimming region of the input image is further displayed on the display unit, changes display of the object frame.

(2) The image processing apparatus according to (1), further including:

a composition setting unit that sets the trimming region such that the object is arranged with a predetermined composition.

(3) The image processing apparatus according to (2),

wherein the object includes a first object and a second object, and

wherein, when the trimming frame is displayed, the display control unit changes displays of a first object frame corresponding to the first object and a second object frame corresponding to the second object using respective different methods.

(4) The image processing apparatus according to (3),

wherein the display control unit causes the second object frame to disappear.

(5) The image processing apparatus according to (4),

wherein the composition setting unit sets the trimming region such that the first object is arranged with the predetermined composition.

(6) The image processing apparatus according to (5),

wherein the composition setting unit sets the trimming region in order to include a third object, the third object being a part of the second object, and

wherein the display control unit causes the second object frame corresponding to the second object other than the third object to disappear.

(7) The image processing apparatus according to (6),

wherein, when a number of the third object is equal to or more than a predetermined number, the display control unit causes the second object frame corresponding to the third object to disappear.

(8) The image processing apparatus according to (3),

wherein, when the trimming frame is displayed, the display control unit displays the second object frame with an animation different from an animation of the first object frame.

(9) The image processing apparatus according to (8),

wherein the display control unit flickers the second object frame.

(10) The image processing apparatus according to any one of (3), (8) or (9),

wherein the display control unit displays the second object frame in a color different from a color of the first object frame.

(11) The image processing apparatus according to any one of (3), or (8) to (10),

wherein the display control unit displays the second object frame with transmittance higher than transmittance of the first object frame.

(12) The image processing apparatus according to any one of (2) to (11), further including:

a focus determining unit that determines whether the object is focused on,

wherein the composition setting unit sets the trimming region, when the object is focused on.

(13) The image processing apparatus according to (1),

wherein the display control unit causes display of the object frame to disappear.

(14) The image processing apparatus according to any one of (1) to (13), further including:

a trimming unit that generates a trimming image of the trimming region from the input image and expands the trimming image to a size of the input image by performing a process of pixel interpolation to increase resolution; and

a recording control unit that records the input image and the trimming image.

(15) The image processing apparatus according to (14),

wherein, when the recorded images are reproduced, the display control unit displays the input image and the trimming frame on the display unit.

(16) The image processing apparatus according to (14),

wherein, when the recorded images are reproduced, the display control unit displays the input image and the trimming image on the display unit in parallel and displays a display on at least one of the input image or the trimming image for distinguishing between the input image and the trimming image.

(17) The image processing apparatus according to (14),

wherein, when the recorded images are reproduced, the display control unit sequentially displays the input image and the trimming image on the display unit and displays an animation in which the trimming region of the input image is expanded to change into the trimming image.

(18) An image processing method including:

when an object frame showing an object included in an input image and the input image are displayed on a display unit and a trimming frame showing a trimming region of the input image is further displayed on the display unit, changing display of the object frame.

(19) A computer readable recording medium on which a program is recorded,

wherein the program causes a computer to realize a function of, when an object frame showing an object included in an input image and the input image are displayed on a display unit and a trimming frame showing a trimming region of the input image is displayed on the display unit, changing display of the object frame.

The present disclosure contains subject matter related to that disclosed in Japanese Priority Patent Application JP 2012-013922 filed in the Japan Patent Office on Jan. 26, 2012, the entire content of which is hereby incorporated by reference.

What is claimed is:

1. An image processing apparatus comprising:
a display control unit that, when an object frame showing an object included in an input image and the input image are displayed on a display unit and a trimming frame showing a trimming region of the input image is further displayed on the display unit, changes display of the object frame.

2. The image processing apparatus according to claim 1, further comprising:
a composition setting unit that sets the trimming region such that the object is arranged with a predetermined composition.

3. The image processing apparatus according to claim 2,
wherein the object includes a first object and a second object, and
wherein, when the trimming frame is displayed, the display control unit changes displays of a first object frame corresponding to the first object and a second object frame corresponding to the second object using respective different methods.

4. The image processing apparatus according to claim 3,
wherein the display control unit causes the second object frame to disappear.

5. The image processing apparatus according to claim 4,
wherein the composition setting unit sets the trimming region such that the first object is arranged with the predetermined composition.

6. The image processing apparatus according to claim 5,
wherein the composition setting unit sets the trimming region in order to include a third object, the third object being a part of the second object, and
wherein the display control unit causes the second object frame corresponding to the second object other than the third object to disappear.

7. The image processing apparatus according to claim 6,
wherein, when a number of the third object is equal to or more than a predetermined number, the display control unit causes the second object frame corresponding to the third object to disappear.

8. The image processing apparatus according to claim 3,
wherein, when the trimming frame is displayed, the display control unit displays the second object frame with an animation different from an animation of the first object frame.

9. The image processing apparatus according to claim 8,
wherein the display control unit flickers the second object frame.

10. The image processing apparatus according to claim 3,
wherein the display control unit displays the second object frame in a color different from a color of the first object frame.

11. The image processing apparatus according to claim 3,
wherein the display control unit displays the second object frame with transmittance higher than transmittance of the first object frame.

12. The image processing apparatus according to claim 2, further comprising:
a focus determining unit that determines whether the object is focused on,
wherein the composition setting unit sets the trimming region, when the object is focused on.

13. The image processing apparatus according to claim 1,
wherein the display control unit causes display of the object frame to disappear.

14. The image processing apparatus according to claim 1, further comprising:
a trimming unit that generates a trimming image of the trimming region from the input image and expands the trimming image to a size of the input image by performing a process of pixel interpolation to increase resolution; and
a recording control unit that records the input image and the trimming image.

15. The image processing apparatus according to claim 14,
wherein, when the recorded images are reproduced, the display control unit displays the input image and the trimming frame on the display unit.

16. The image processing apparatus according to claim 14,
wherein, when the recorded images are reproduced, the display control unit displays the input image and the trimming image on the display unit in parallel and displays a display on at least one of the input image or the trimming image for distinguishing between the input image and the trimming image.

17. The image processing apparatus according to claim 14,
wherein, when the recorded images are reproduced, the display control unit sequentially displays the input image and the trimming image on the display unit and displays an animation in which the trimming region of the input image is expanded to change into the trimming image.

18. An image processing method comprising:
when an object frame showing an object included in an input image and the input image are displayed on a display unit and a trimming frame showing a trimming region of the input image is further displayed on the display unit, changing display of the object frame.

19. A computer readable recording medium on which a program is recorded,
wherein the program causes a computer to realize a function of, when an object frame showing an object included in an input image and the input image are displayed on a display unit and a trimming frame showing a trimming region of the input image is displayed on the display unit, changing display of the object frame.
